(19) United States
(12) Patent Application Publication
(10) Pub. No.: US 2025/0327972 A1
(43) Pub. Date: Oct. 23, 2025

(54) SEMICONDUCTOR PHOTONICS DEVICE AND METHODS OF FORMATION

(71) Applicant: Taiwan Semiconductor Manufacturing Company, Ltd., Hsinchu (TW)

(72) Inventors: Shih Chi LIU, Hsinchu City (TW); Wei Chun WANG, Taipei City (TW); Chi-Yuan SHIH, Hsinchu (TW); Wen-Chuan TAI, Hsinchu City (TW); Cheng-Che TUNG, Hsinchu (TW)

(21) Appl. No.: 18/781,333

(22) Filed: Jul. 23, 2024

Related U.S. Application Data
(60) Provisional application No. 63/637,056, filed on Apr. 22, 2024.

(51) Int. Cl. G02B 6/124; G02B 6/125; G02B 6/13

(52) U.S. Cl. CPC G02B 6/124; G02B 6/125; G02B 6/13

(57) ABSTRACT

A semiconductor photonics device includes a curved waveguide structure (e.g., a waveguide structure having a bended top view shape) that is optically coupled to a grating coupler that is configured to receive high-powered optical signals. The curvature of the waveguide structure resists concentration of optical power in certain areas within the waveguide structure, which enables the waveguide structure to handle the high-powered optical signals without (or with minimal likelihood of) being damaged by the high-powered optical signals. This enables the waveguide structure to support and facilitate high signal speeds and high optical bandwidth in the semiconductor photonics device, which enables a high system link budget to be achieved for optical communication.

### CROSS-REFERENCE TO RELATED APPLICATION

This Patent Application claims priority to U.S. Provisional Patent Application No. 63/637,056, filed on Apr. 22, 2024, and entitled “SEMICONDUCTOR PHOTONICS DEVICE AND METHODS OF FORMATION.” The disclosure of the prior Application is considered part of and is incorporated by reference into this Patent Application.

### BACKGROUND

A semiconductor photonics device may be configured to use optical signals for high-speed, high-bandwidth, and secure optical communication between integrated circuits and/or semiconductor dies of the semiconductor photonics device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C are diagrams of an example of a semiconductor photonics device described herein.

FIGS. 2A-2J are diagrams of an example implementation of forming a semiconductor photonics device described herein.

FIG. 3 is a diagram of an example of a semiconductor photonics device described herein.

FIG. 4 is a diagram of an example of a semiconductor photonics device described herein.

FIG. 5 is a diagram of an example of a semiconductor photonics device described herein.

FIG. 6 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some cases, a semiconductor photonics device may include a grating coupler and a waveguide structure that couples input optical signals from the grating coupler to another photonics structure (e.g., a splitter structure, a modulator structure, a photodetector structure) in the semiconductor photonics device. To enable the semiconductor photonics device to operate at high signal speeds and high optical bandwidth, the grating coupler may be configured to receive high-powered optical signals (e.g., high-powered laser signals). While the use of high-powered optical signals may enable a high system link budget for optical communication to be achieved for the semiconductor photonics device, high-powered optical signals may cause damage to the crystal structure of the waveguide structure if the power level of the high-powered optical signals is too high. As a result, the use of high-powered optical signals in the semiconductor photonics device may cause wear-out and/or failure of the waveguide structure to be accelerated.

In some implementations described herein, a semiconductor photonics device includes a curved waveguide structure (e.g., a waveguide structure having a bent top view shape) that is optically coupled to a grating coupler that is configured to receive high-powered optical signals. The curvature of the waveguide structure resists concentration of optical power in certain areas within the waveguide structure, which enables the waveguide structure to handle the high-powered optical signals without (or with minimal likelihood of) being damaged by the high-powered optical signals. This enables the waveguide structure to support and facilitate high signal speeds and high optical bandwidth in the semiconductor photonics device, which enables a high system link budget to be achieved for optical communication.

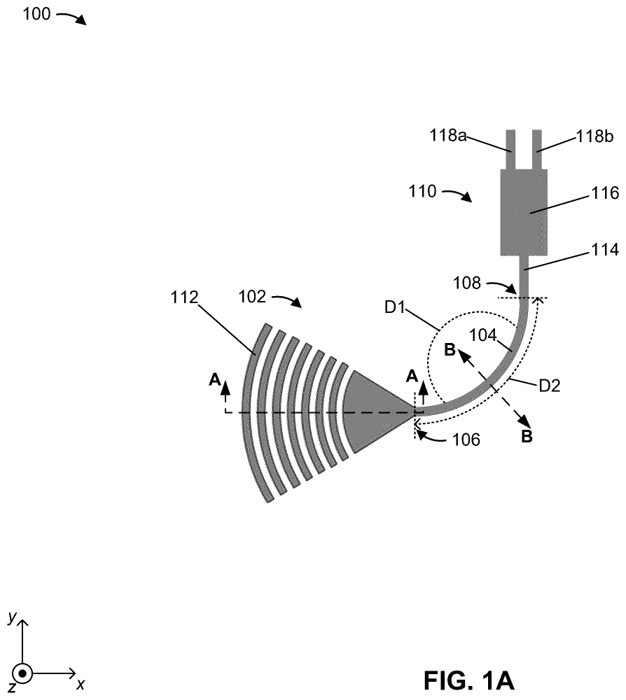

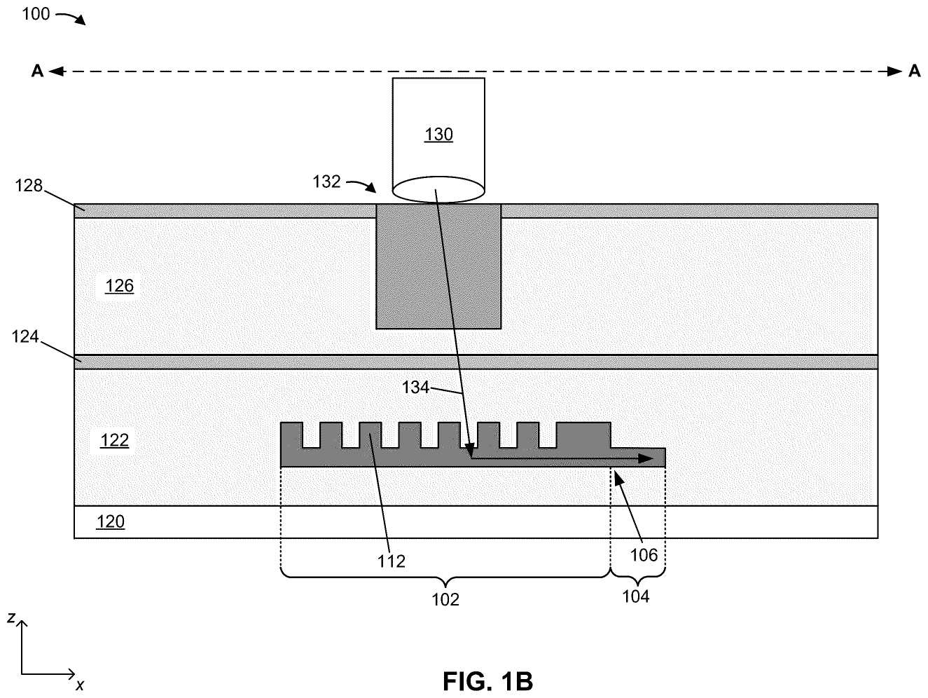

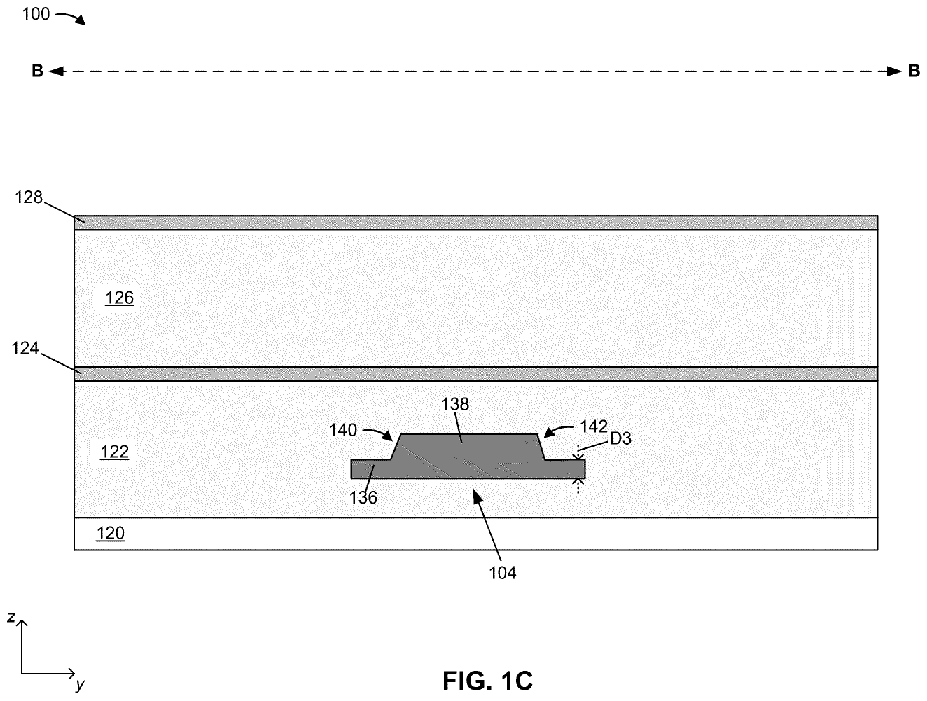

FIGS. 1A-1C are diagrams of an example of a semiconductor photonics device 100 described herein. The semiconductor photonics device 100 may include a photonic integrated circuit that includes one or more components configured to process optical signals (e.g., for optical communication).

FIG. 1A illustrates a top view of the photonic integrated circuit of the semiconductor photonics device 100. As shown in FIG. 1A, the photonic integrated circuit of the semiconductor photonics device 100 may include a grating coupler 102 and a waveguide structure 104 optically coupled to the grating coupler 102 at a first end 106 of the waveguide structure 104. The waveguide structure 104 may be optically coupled to another component (such as an optical splitter 110) at a second end 108 of the waveguide structure 104 opposing the first end 106.

The grating coupler 102 may be configured to receive optical signals (e.g., laser signals or incident light from an input optical fiber or another type of external optical connection) and to diffract the optical signals from an off-plane direction (e.g., a z-direction) to an in-plane direction (e.g., an x-direction) that is in the plane (e.g., an x-y plane) of the first end 106 of the waveguide structure 104 (e.g., for reception of the optical signal).

The grating coupler 102 may include a plurality of gratings 112. In some implementations, the gratings 112 may be periodic, and the periodicity of the gratings 112 may be selected to achieve diffraction of one or more wavelengths of optical signals. In some implementations, the periodicity of the gratings 112 may be selected based on the wavelength(s) that are to be used for optical communication, may be selected based on the wavelength(s) that are to be used for wavelength division multiplexing (WDM), and/or for another purpose.

In some implementations, the grating coupler 102 is formed of a semiconductor material such as silicon (Si), germanium (Ge), and/or silicon germanium (SiGe), among other examples. In some implementations, the grating coupler 102 is formed of a dielectric material such as silicon nitride (SiₓN_{y} such as Si₃N₄) and/or silicon oxide (SiOₓ such as SiO₂), among other examples. In some implementations, the grating coupler 102 is a hybrid grating coupler structure that includes a dual-layer structure having a dielectric portion and a semiconductor portion.

The first end 106 of the waveguide structure 104 may be located laterally adjacent to the first end 106 of the waveguide structure 104 in the x-direction. The waveguide structure 104 may be configured to provide optical signals between the grating coupler 102 and the optical splitter 110. The optical signals may be received at the grating coupler 102, and may be provided to the waveguide structure 104 at the first end 106 of the waveguide structure 104. The optical signals may propagate through the waveguide structure 104 from the first end 106 to the second end 108, where the optical signals are provided to the optical splitter 110.

The waveguide structure 104 may include a strip waveguide, a rib waveguide, a ridge waveguide, a deep rib (drip) waveguide, and/or another type of waveguide structure. In some implementations, the waveguide structure 104 is formed of a semiconductor material such as silicon (Si), germanium (Ge), and/or silicon germanium (SiGe), among other examples. In some implementations, the waveguide structure 104 is formed of a dielectric material such as silicon nitride (SiₓN_{y} such as Si₃N₄) and/or silicon oxide (SiOₓ such as SiO₂), among other examples. In some implementations, the grating coupler 102 and the waveguide structure 104 are both formed from the same semiconductor layer such that the first end 106 of the waveguide structure 104 is physically coupled to the grating coupler 102. In some implementations, the grating coupler 102 is formed from a semiconductor layer and the waveguide structure 104 is formed from a dielectric layer, and the first end 106 of the waveguide structure 104 is physically spaced apart from the grating coupler 102.

The optical splitter 110 may include an input 114, a main body 116, and outputs 118a and 118b. The input 114 may be optically coupled to the second end 108 of the waveguide structure 104 and may receive an optical signal from the waveguide structure 104. The main body 116 may be configured to split the optical signal into a plurality of output optical signals that propagate through respective outputs 118a and 118b. Splitting the optical signal reduces the optical power of the optical signal and enables the output optical signals to be processed by other optical components (such as optical modulators, optical resonators, polarizers, and/or photodetectors, among other examples) in the semiconductor photonics device 100.

In some implementations, the optical splitter 110 is formed of a semiconductor material such as silicon (Si), germanium (Ge), and/or silicon germanium (SiGe), among other examples. In some implementations, the optical splitter 110 is formed of a dielectric material such as silicon nitride (SiₓN_{y} such as Si₃N₄) and/or silicon oxide (SiOₓ such as SiO₂), among other examples. In some implementations, the optical splitter 110 and the waveguide structure 104 are both formed from the same semiconductor layer such that the second end 108 of the waveguide structure 104 is physically coupled to the input 114 of the optical splitter 110. In some implementations, the optical splitter 110 is formed from a semiconductor layer and the waveguide structure 104 is formed from a dielectric layer, and the second end 108 of the waveguide structure 104 is physically spaced apart from the input 114 of the optical splitter 110.

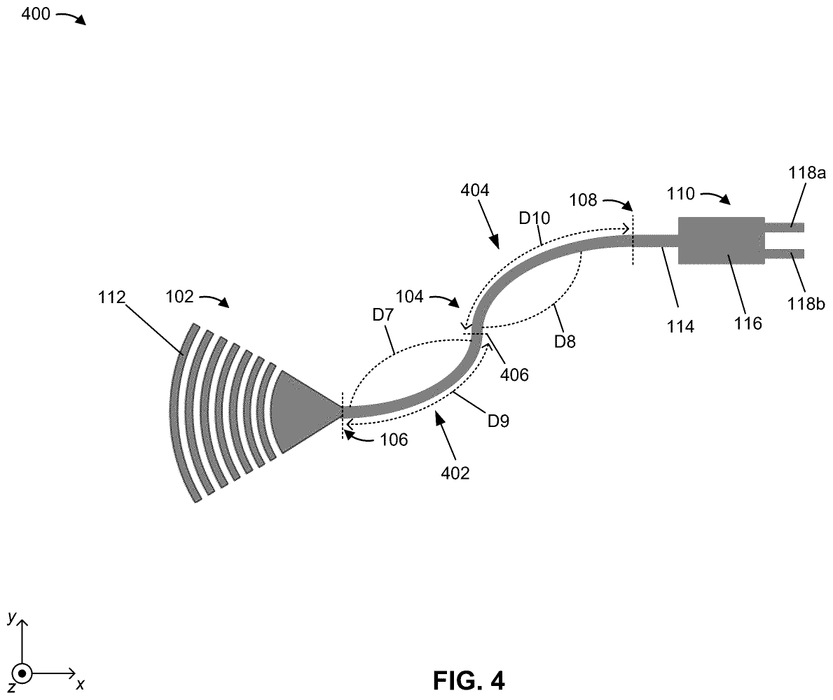

As further shown in FIG. 1A, the waveguide structure 104 has a curved (or arced) top view shape between the first end 106 and the second end 108 of the waveguide structure 104. In the example illustrated in FIG. 1A, the waveguide structure 104 has a semi-circular top view shape between the first end 106 of the waveguide structure 104 and the second end 108 of the waveguide structure 104. However, other curved top view shapes for the waveguide structure 104 are within the scope of the present disclosure. Other example top view shapes for the waveguide structure 104 are illustrated and described in connection with FIGS. 4-6.

The curved top view shape of the waveguide structure 104 results in the first end 106 of the waveguide structure 104 being oriented in (e.g., facing) a first direction (e.g., y-direction) and the second end 108 of the waveguide structure 104 being oriented in (e.g., facing) a second direction (x-direction) that is different from the first direction. In some implementations, the first end 106 of the waveguide structure 104 is oriented in a first direction and the second end 108 of the waveguide structure 104 is oriented in second direction that is approximately orthogonal to the first direction. In some implementations, the first end 106 of the waveguide structure 104 is oriented in a first direction and the second end 108 of the waveguide structure 104 is oriented in second direction that is non-orthogonal to the first direction.

The curved top view shape of the waveguide structure 104 enables the waveguide structure 104 to carry high-power optical signals while limiting propagation of defects along the waveguide structure 104 that may be caused by the high-power optical signals. Most of the optical power of high-power optical signals that propagate through the waveguide structure 104 may be concentrated near the cross-sectional center of the waveguide structure 104. This concentration of optical power can cause damage (e.g., in the form of crystal defects or crystal dislocation) to be initiated at the cross-sectional center of the waveguide structure 104. If the waveguide structure 104 were substantially straight between the first end 106 and the second end 108, these crystal defects would be permitted to propagate along the length of the waveguide structure 104, and could potentially cause significant propagation loss in the waveguide structure 104 and/or failure of the waveguide structure 104. The curve of the waveguide structure 104 enables damage in the waveguide structure 104 from the high-power optical signals to be contained within particular locations along the curve of the waveguide structure 104, thereby limiting the propagation of the damage along particular orientations in the waveguide structure 104. In other words, the curved top view shape of the waveguide structure 104 inhibits crystal dislocations in the waveguide structure 104 from propagating further along the length of the waveguide structure 104 from the location where the crystal dislocations originate.

As further shown in FIG. 1A, the waveguide structure 104 may have one or more dimensions. An example dimension D1 of the waveguide structure 104 includes an arc angle of the waveguide structure 104, which is the angle between the first end 106 of the waveguide structure and the second end 108 of the waveguide structure 104. In some implementations, the arc angle of the waveguide structure 104 is included in a range of approximately 30 degrees to approximately 90 degrees, which enables the localization of crystal dislocations in the waveguide structure 104 while enabling a low bending loss to be achieved for the waveguide structure 104. However, other values and ranges for the arc angle of the waveguide structure 104 are within the scope of the present disclosure.

Another example dimension D2 includes an arc length, which is the length of the curve of the waveguide structure 104 between the first end 106 and the second end 108. In some implementations, the arc length of the waveguide structure 104 is included in a range of approximately 10 microns to approximately 20 microns, which enables a low optical bending loss to be achieved for the waveguide structure 104 while enabling a compact size to be achieved for the semiconductor photonics device 100. However, other values and ranges for the arc length of the waveguide structure 104 are within the scope of the present disclosure.

FIG. 1B illustrates a cross-section view along the line A-A in FIG. 1A. Thus, the cross-section view in FIG. 1B is along the x-direction in the semiconductor photonics device 100. As shown in FIG. 1B, the semiconductor photonics device 100 may include a plurality of layers, including a substrate layer 120, a dielectric layer 122 above the substrate layer 120, a dielectric layer 124 above the dielectric layer 122, a dielectric layer 126 above the dielectric layer 124, and/or a dielectric layer 128 above the dielectric layer 126, among other examples.

The substrate layer 120 may include a semiconductor layer such as a silicon (Si) layer, a germanium (Ge) layer, a silicon germanium (SiGe) layer, a layer including a III-V semiconductor material, and/or another type of substrate material.

The dielectric layers 124 and 128 may each include etch stop layers (ESLs), passivation layers, isolation layers, and/or other types of dielectric layers. The dielectric layers 122 and 126 may each include an interlayer dielectric (ILD). The dielectric layers 122, 124, 126, and 128 may each include one or more dielectric materials, such as a silicon oxide (SiOₓ), a silicon nitride (SiₓN_{y}), a silicon oxynitride (SiON), undoped silicate glass (USG), phosphosilicate glass (PSG), borophosphosilicate glass (BPSG), fluorinated silicate glass (FSG), carbon doped silicon oxide, and/or another dielectric material. In some implementations, two or more of the dielectric layers 122, 124, 126, and/or 128 include the same dielectric material and/or the same composition of dielectric materials. In some implementations, two or more of the dielectric layers 122, 124, 126, and/or 128 include different dielectric materials and/or different compositions of dielectric materials.

As further shown in FIG. 1B, the grating coupler 102 and the waveguide structure 104 may be included in the dielectric layer 122 such that the grating coupler 102 and the waveguide structure 104 are encapsulated in the dielectric layer 122. The optical splitter 110 (not visible in the cross-section view along the line A-A) may also be included in the dielectric layer 122. The grating coupler 102 and the first end 106 of the waveguide structure 104 may be optically coupled and/or physically coupled such that the grating coupler 102 and the waveguide structure 104 are laterally adjacent to each other. Alternatively, the waveguide structure 104 may be located at a higher or lower vertical (z-direction) position in the dielectric layer 122 relative to the grating coupler 102.

As further shown in FIG. 1B, the grating coupler 102 may be optically coupled to an input optical fiber 130. The input optical fiber 130 may be positioned above a recess 132 in the semiconductor photonics device 100, and may be configured to provide optical signals 134 to the grating coupler 102. Alternatively, the input optical fiber 130 may be positioned laterally adjacent to a side of the semiconductor photonics device 100. The recess 132 may be filled with a dielectric material such as silicon oxide (SiOₓ) and/or silicon nitride (SiₓN_{y}), among other examples.

FIG. 1C illustrates a cross-section view along the line B-B in FIG. 1A. Thus, the cross-section view in FIG. 1C is across the waveguide structure 104. As shown in FIG. 1C, the waveguide structure 104 may have a rib cross-sectional profile in which the waveguide structure 104 includes a base portion 136 and a core portion 138 on the base portion 136. The base portion 136 extends laterally outward from the core portion 138, and the core portion 138 extends above the base portion 136. The base portion 136 may also be referred to as a slab portion of the waveguide structure 104. Alternatively, the base portion 136 may be omitted, and the waveguide structure 104 may be a strip waveguide structure.

In some implementations, a height or thickness of the base portion 136 (indicated in FIG. 1C as dimension D3) may be included in a range of approximately 70 nanometers to approximately 130 nanometers. If the thickness of the base portion 136 (sometimes referred to as slab height) is less than approximately 70 nanometers, the optical loss in the waveguide structure 104 may increase due to increased sidewall optical scattering. If the thickness of the base portion 136 is greater than approximately 130 nanometers, the optical mode confinement in the waveguide structure 104 may decrease due to increased dispersion of optical signals in the base portion 136. Selecting a thickness for the base portion 136 in the range of approximately 70 nanometers to approximately 130 nanometers enables a high amount of optical mode confinement to be achieved, and enables low optical loss to be achieved in the waveguide structure 104. However, other values and ranges other than approximately 70 nanometers to approximately 130 nanometers for the thickness of the base portion 136 are within the scope of the present disclosure.

In some implementations, the waveguide structure 104 may have a non-uniform thickness for the base portion 136 along the length of the waveguide structure 104 (e.g., between the first end 106 and the second end 108), which may enable optical mode confinement, optical signal loss, and/or crystal dislocation damage confinement to be optimized. In some implementations, the base portion 136 of the waveguide structure 104 may have different thicknesses on opposing sides of the waveguide structure 104, which may enable further optimization and tuning of optical mode confinement, optical signal loss, and/or crystal dislocation damage confinement for the waveguide structure 104. For example, the base portion 136 adjacent to a first side 140 of the core portion 138 may have a first thickness, the base portion 136 adjacent to a second side 142 of the core portion 138 may have a second thickness, and the first thickness and the second thickness may be different thicknesses.

As indicated above, FIGS. 1A-1C are provided as an example. Other examples may differ from what is described with regard to FIGS. 1A-1C.

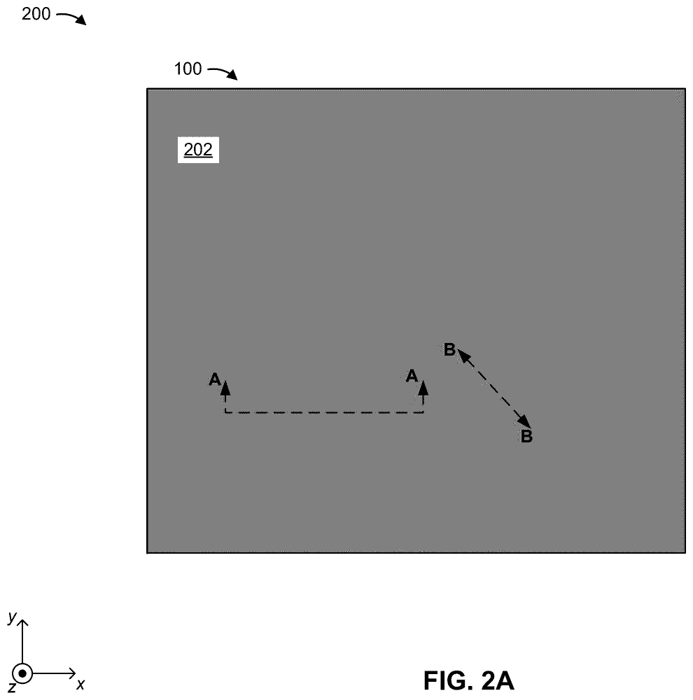

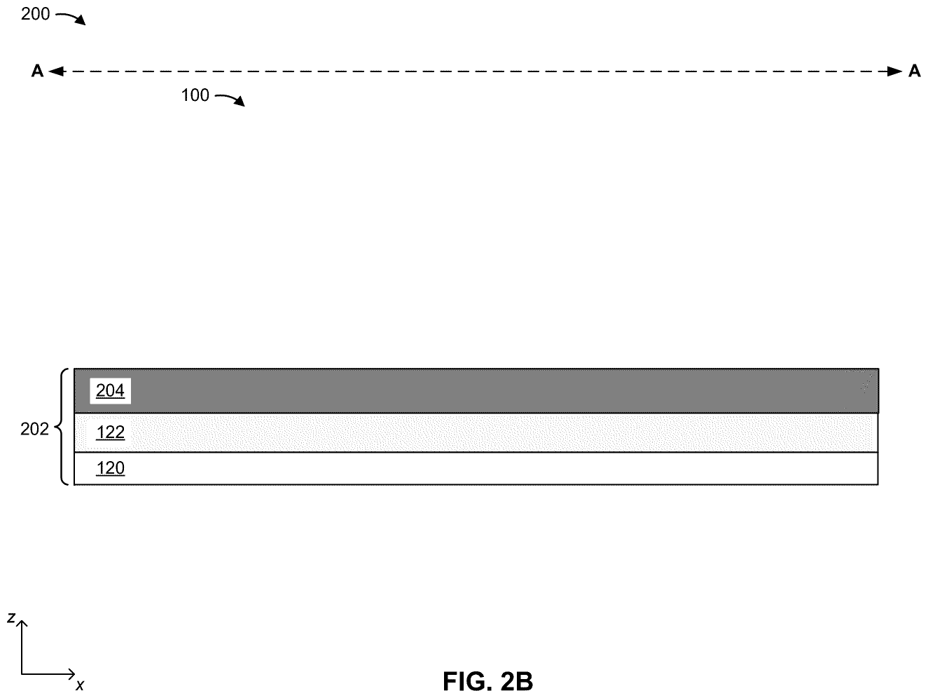

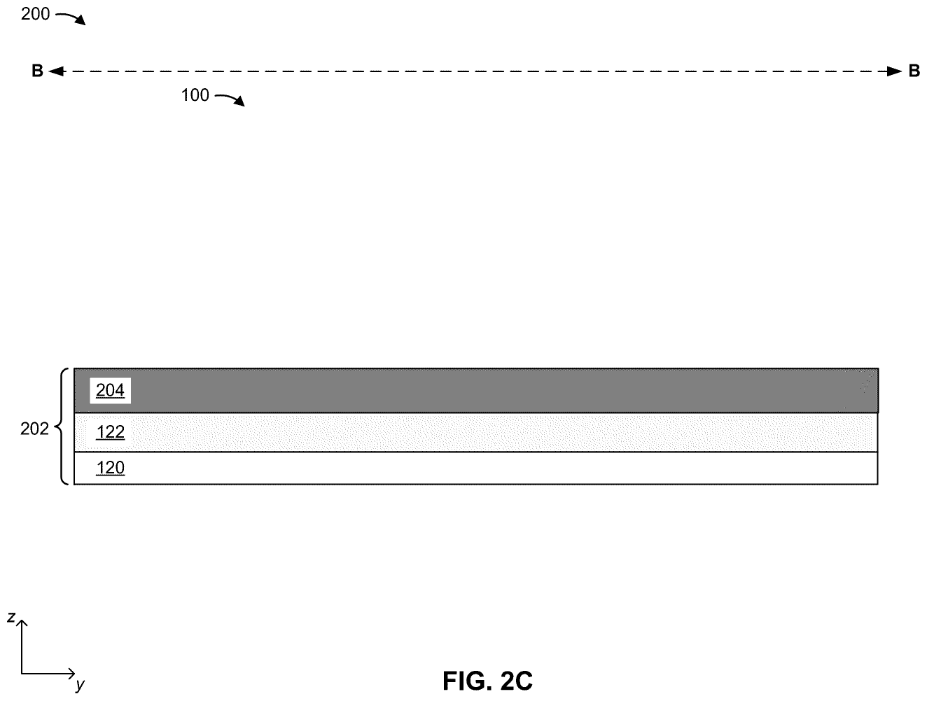

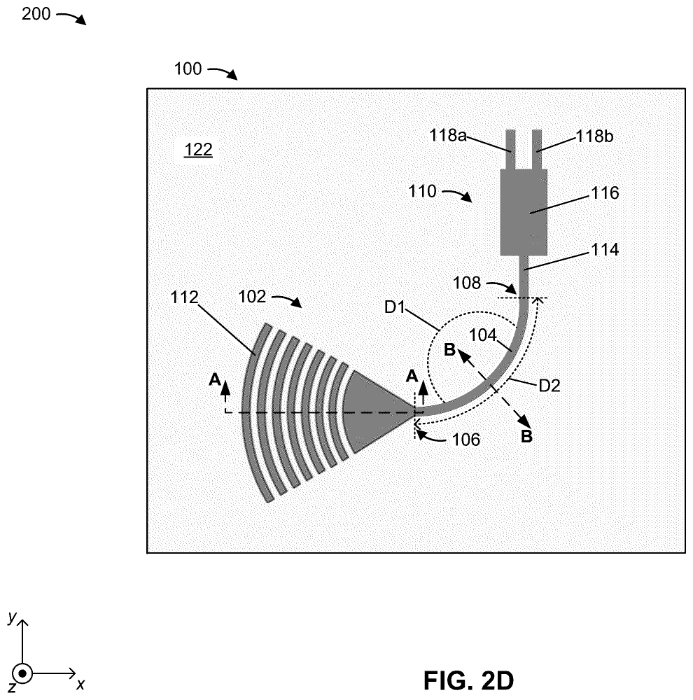

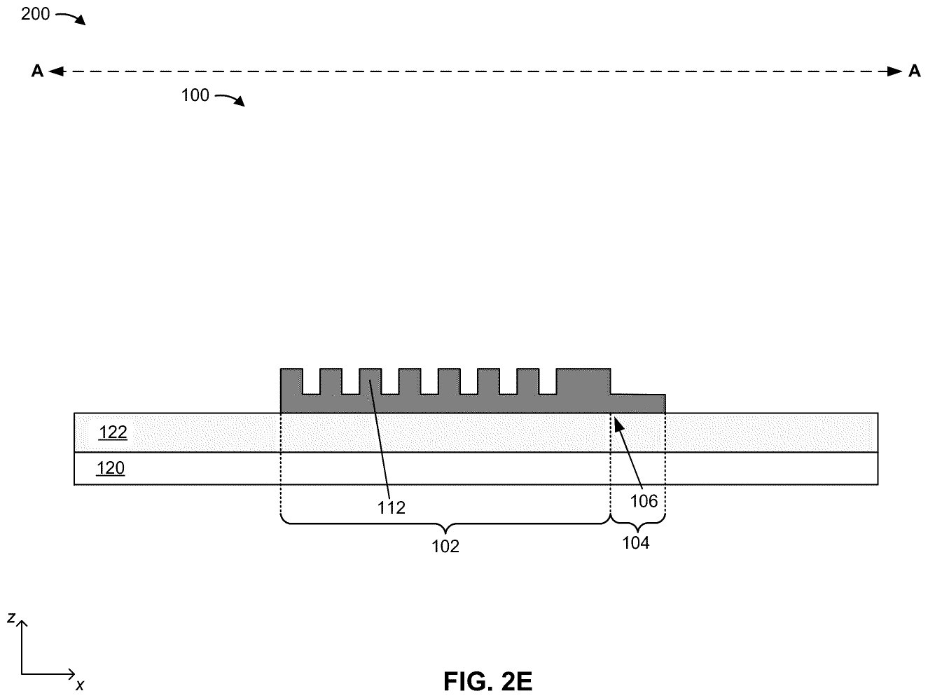

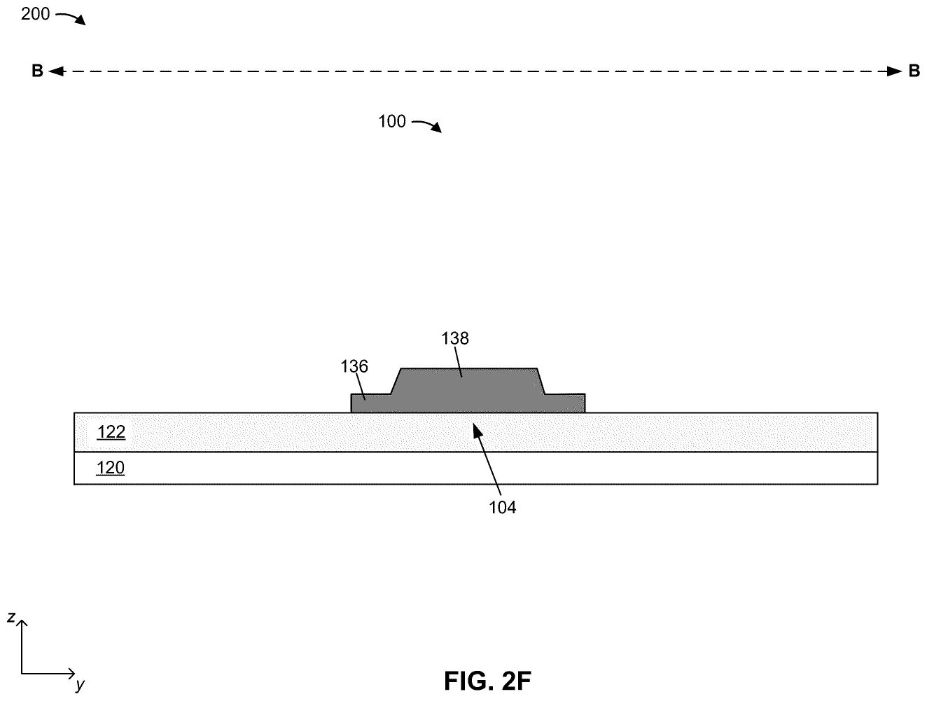

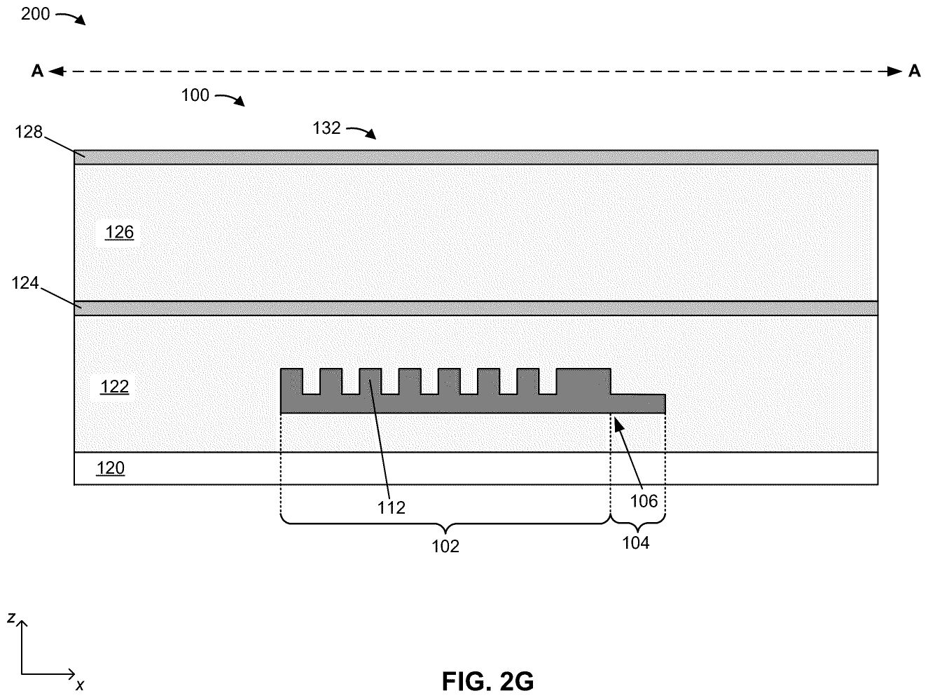

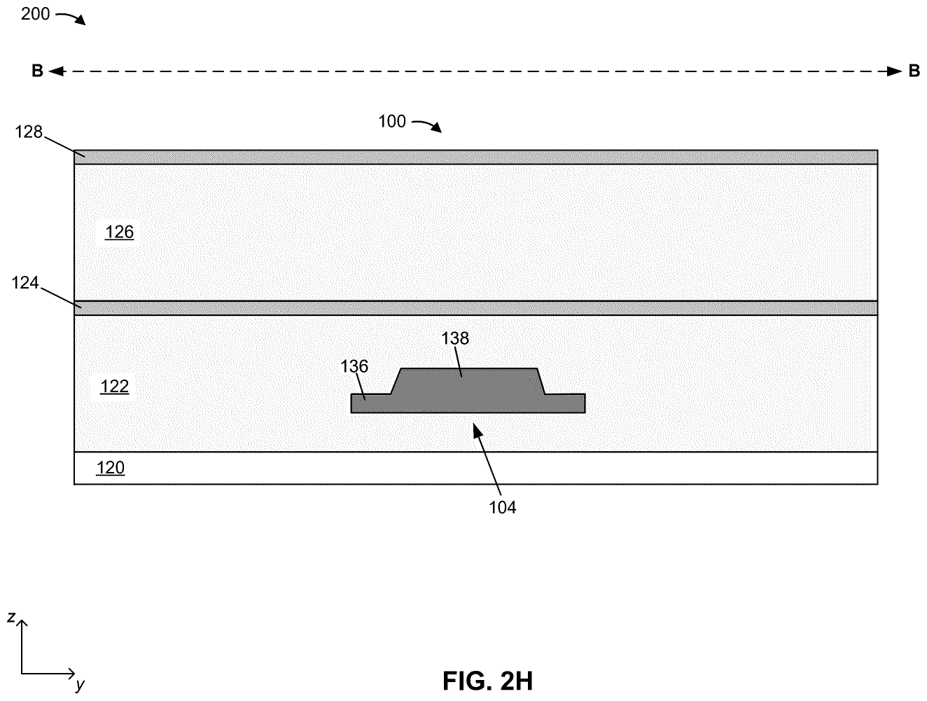

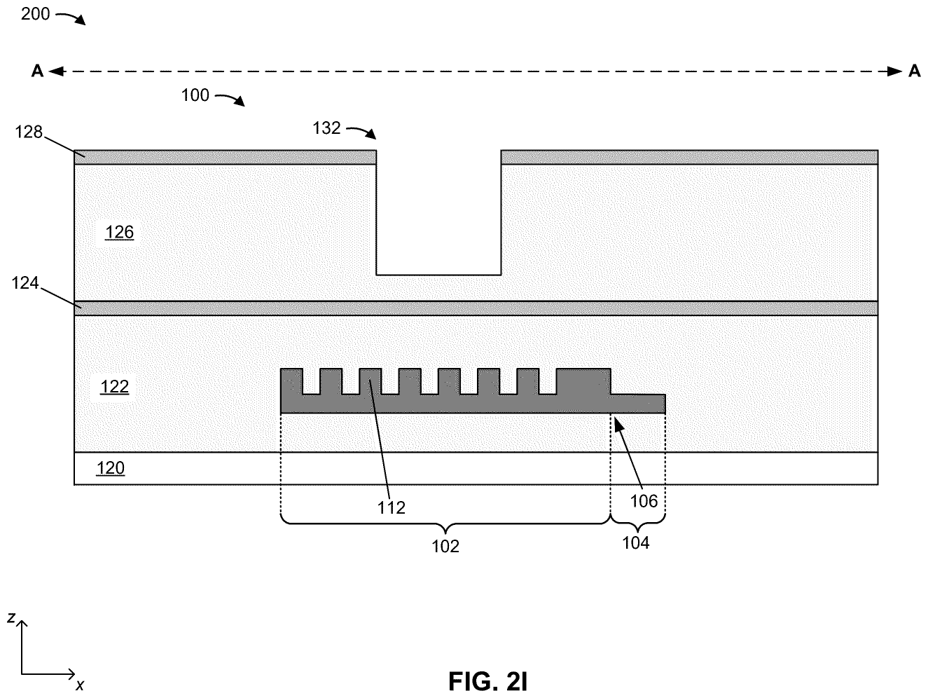

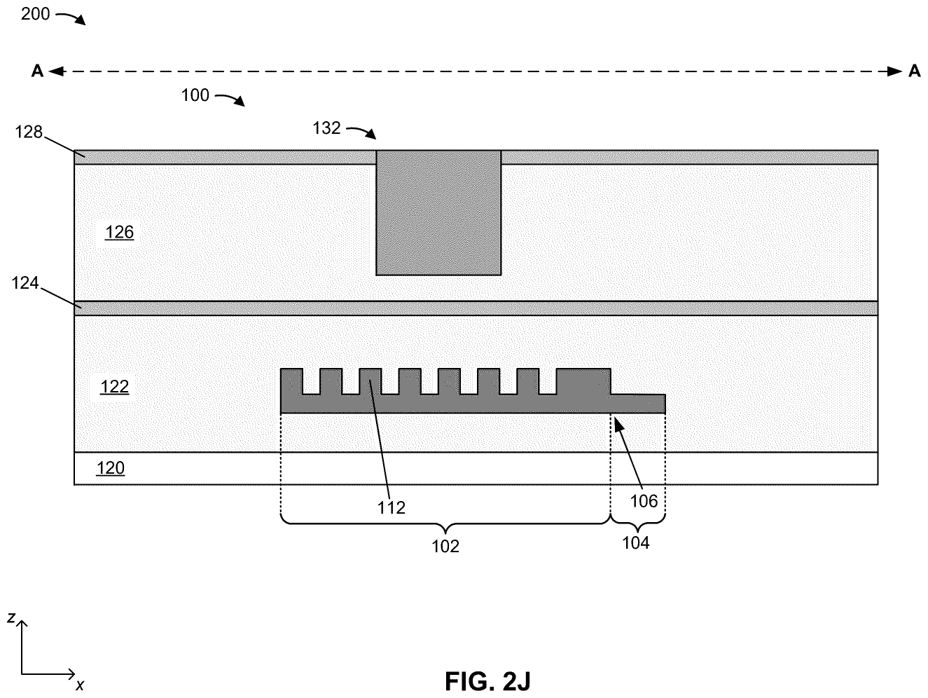

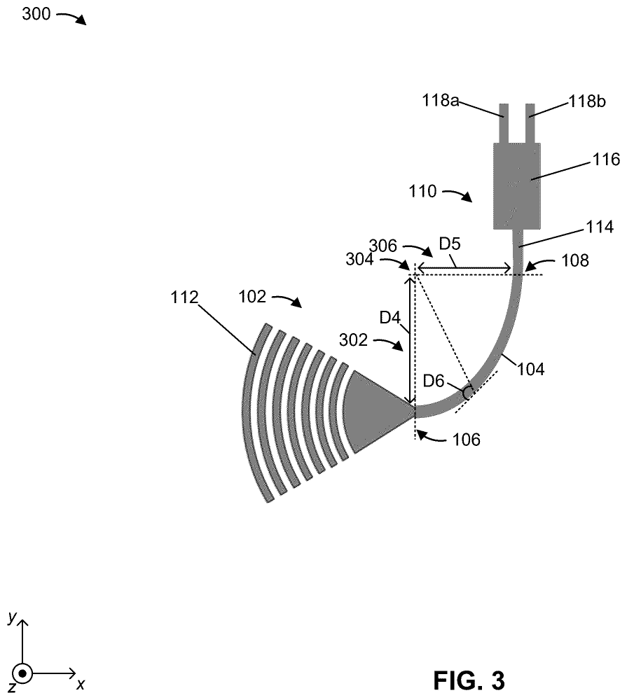

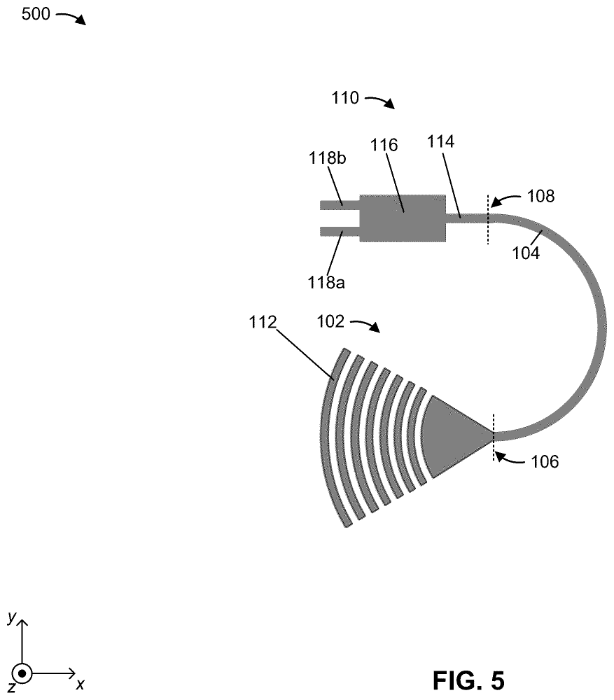

FIGS. 2A-2J are diagrams of an example implementation 200 of forming a semiconductor photonics device described herein. While the example implementation 200 is illustrated in connection with forming the semiconductor photonics device 100, the operations and techniques illustrated and described in connection with FIGS. 2A-2J may be performed to form other semiconductor photonics devices described herein, such as a semiconductor photonics device 300 illustrated and described in connection with FIG. 3, a semiconductor photonics device 400 illustrated and described in connection with FIG. 4, and/or a semiconductor photonics device 500 illustrated and described in connection with FIG. 5, among other examples.

As shown in FIG. 2A, a substrate 202 of the semiconductor photonics device 100 may be provided. As shown in FIGS. 2B and 2C, the substrate 202 may include a silicon on insulator (SOI) substrate that includes the substrate layer 120 (e.g., a silicon (Si) substrate and/or another type of semiconductor substrate), a portion of the dielectric layer 122 (e.g., a buried oxide or bottom oxide (BOX) layer and/or another type of insulator layer) over and/or on the substrate layer 120, and a semiconductor layer 204 (e.g., a silicon (Si) layer and/or another type of semiconductor layer) over and/or on the portion of the dielectric layer 122. Alternatively, the substrate layer 122 may be provided as a semiconductor wafer, and a deposition tool may be used to form the portion of the dielectric layer 122 over and/or on the substrate layer 120, and may be used to form the semiconductor layer 204 over and/or on the portion of the dielectric layer 122. A deposition tool may be used to deposit the portion of the dielectric layer 122 using a chemical vapor deposition (CVD) technique, a physical vapor deposition (PVD) technique, an oxidation technique (e.g., a thermal oxidation technique), and/or another type of deposition technique. A deposition tool may be used to form the semiconductor layer 204 using an epitaxy technique and/or another type of deposition technique.

As shown in FIGS. 2D-2F, the grating coupler 102, the waveguide structure 104, and the optical splitter 110 may be formed above the dielectric layer 122. In some implementations, the grating coupler 102, the waveguide structure 104, and/or the optical splitter 110 are formed from the semiconductor layer 204 such that the grating coupler 102, the waveguide structure 104, and/or the optical splitter 110 include a semiconductor material. In implementations in which the grating coupler 102 and the waveguide structure 104 are formed from the semiconductor layer 204, the first end 106 of the waveguide structure 104 may be optically coupled and physically coupled to the grating coupler 102. In implementations in which the waveguide structure 104 and the optical splitter 110 are formed from the semiconductor layer 204, the second end 108 of the waveguide structure 104 may be optically coupled and physically coupled to the optical splitter 110. The waveguide structure 104 may be patterned and formed to have a curved or arced top view shape, such as one or more of the example top view shapes illustrated and described herein, for example, in connection with FIGS. 1A-1C, 3, 4, and/or 5, among other examples.

In some implementations, a hard mask layer may be formed over and/or on the semiconductor layer 204, and a pattern in the hard mask layer may be used to etch the semiconductor layer 204 to form the grating coupler 102, the waveguide structure 104, and the optical splitter 110. Deposition tools may be used to deposit the hard mask layer on the semiconductor layer 204 (e.g., using a CVD technique, a PVD technique, and/or another type of deposition technique) and a photoresist layer on the hard mask layer (e.g., using a spin-coating technique and/or another type of deposition technique). The hard mask layer may include a silicon nitride (SiₓN_{y} such as Si₃N₄) material or another hard mask material. The photoresist layer may include a light-sensitive material that can be patterned using an exposure tool such as a deep ultraviolet (DUV) lithography tool and/or an extreme ultraviolet (EUV) lithography tool, among other examples.

An exposure tool may be used to expose the photoresist layer to a radiation source to form a pattern in the photoresist layer. A developer tool may be used to develop and remove portions of the photoresist layer to expose the pattern. An etch tool may be used to etch the hard mask layer to transfer the pattern from the photoresist layer to the hard mask layer. An etch tool may then be used to etch the semiconductor layer 204 based on the pattern in the hard mask layer to remove material from the semiconductor layer 204 to form the grating coupler 102, the waveguide structure 104, and the optical splitter 110. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique).

As shown in FIGS. 2G and 2H, additional material of the dielectric layer 122 may be deposited around and/or on the grating coupler 102, the waveguide structure 104, and the optical splitter 110 using a CVD technique, a PVD technique, an oxidation technique, and/or another type of deposition technique. In some implementations, a planarization tool is used to perform a planarization operation (e.g., a chemical mechanical polishing/planarization (CMP) operation) to planarize the dielectric layer 122.

As further shown in FIGS. 2G and 2H, the dielectric layers 124, 126, and 128 may be formed over and/or on the dielectric layer 122. A deposition tool may be used to deposit the dielectric layers 124, 126, and 128 using a CVD technique, a PVD technique, an atomic layer deposition (ALD) technique, an oxidation technique, and/or another suitable deposition technique. Each of the dielectric layers 124, 126, and 128 may be deposited in one or more deposition operations. In some implementations, a planarization tool may be used to planarize the dielectric layers 124, 126, and 128 after the dielectric layers 124, 126, and 128 are deposited.

Additionally and/or alternatively, a dielectric layer (e.g., a silicon nitride (SiₓN_{y}) layer) may be deposited above the optical components formed from the semiconductor layer 204, and the grating coupler 102, the waveguide structure 104, and/or the optical splitter 110 may be formed from the dielectric layer. Thus, the grating coupler 102 may include a dielectric (or hybrid semiconductor and dielectric) grating coupler, the waveguide structure 104 may include a dielectric waveguide, and/or the optical splitter 110 may include a dielectric optical splitter.

As shown in FIG. 2I, the recess 132 may be formed above the grating coupler 102. The recess 132 may be formed in the dielectric layers 126 and/or 128. In some implementations, a pattern in a photoresist layer is used to etch the dielectric layers 126 and/or 128 to form the recess 132. In these implementations, a deposition tool may be used to form the photoresist layer on the dielectric layer 128. An exposure tool may be used to expose the photoresist layer to a radiation source to pattern the photoresist layer. A developer tool may be used to develop and remove portions of the photoresist layer to expose the pattern. An etch tool may be used to etch the dielectric layers 126 and/or 128 based on the pattern to form the recess 132. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recess 132 based on a pattern.

As shown in FIG. 2J, a deposition tool and/or a plating tool may be used to deposit dielectric material into the recess 132 using a CVD technique, a PVD technique, an ALD technique, and/or another suitable deposition technique. In some implementations, a planarization tool may be used to planarize the dielectric material after the dielectric material is deposited.

As indicated above, FIGS. 2A-2J are provided as an example. Other examples may differ from what is described with regard to FIGS. 2A-2J.

FIG. 3 is a diagram of an example of a semiconductor photonics device 300 described herein. The semiconductor photonics device 300 may include a photonic integrated circuit that includes one or more components configured to process optical signals (e.g., for optical communication).

As shown in FIG. 3, the semiconductor photonics device 300 includes a similar combination and arrangement of optical components as the semiconductor photonics device 100. For example, the semiconductor photonics device 300 may include a grating coupler 102, a waveguide structure 104, and an optical splitter 110, where the first end 106 of the waveguide structure 104 is optically coupled and/or physically coupled to the grating coupler 102, and where the second end 108 of the waveguide structure 104 is optically coupled and/or physically coupled to the optical splitter 110.

However, in the semiconductor photonics device 300, the waveguide structure 104 has a non-uniform curve or arc shape. For example, the waveguide structure 104 may have a semi-elliptical top view shape between the first end 106 of the waveguide structure 104 and the second end 108 of the waveguide structure 104. Thus, the waveguide structure 104 has an eccentricity (e.g., a numerical representation of the amount that the waveguide structure 104 deviates from being a circle) that is greater than the eccentricity of the waveguide structure 104 in the semiconductor photonics device 100. For example, the top view shape of the waveguide structure 104 in the semiconductor photonics device 100 may have an eccentricity of approximately 0, and the top view shape of the waveguide structure 104 in the semiconductor photonics device 100 may have an eccentricity of greater than 0 and less than 1.

The waveguide structure 104 has a semi-major axis 302 between the first end 106 and a logical center 304 of an ellipse of the semi-elliptical top view shape of the waveguide structure, and has a semi-minor axis 306 between the second end 108 and the logical center 304. Alternatively, the semi-major axis 302 may be located at the second end 108 and the semi-minor axis 306 may be located at the first end 106. The length of the semi-major axis 302 (indicated in FIG. 3 as dimension D4) is greater than the length of the semi-minor axis 306 (indicated in FIG. 3 as dimension D5).

Because of the non-uniform curve or arc shape of the waveguide structure 104, the waveguide structure 104 has a non-uniform tangent angle (indicated in FIG. 3 as dimension D6). For example, the tangent angle may be approximately 90 degrees at the first end 106 and at the second end 108, and may be greater than 90 degrees or less than 90 degrees between the first end 106 and the second end 108.

As indicated above, FIG. 3 is provided as an example. Other examples may differ from what is described with regard to FIG. 3.

FIG. 4 is a diagram of an example of a semiconductor photonics device 400 described herein. The semiconductor photonics device 400 may include a photonic integrated circuit that includes one or more components configured to process optical signals (e.g., for optical communication).

As shown in FIG. 4, the semiconductor photonics device 400 includes a similar combination and arrangement of optical components as the semiconductor photonics device 100. For example, the semiconductor photonics device 400 may include a grating coupler 102, a waveguide structure 104, and an optical splitter 110, where the first end 106 of the waveguide structure 104 is optically coupled and/or physically coupled to the grating coupler 102, and where the second end 108 of the waveguide structure 104 is optically coupled and/or physically coupled to the optical splitter 110.

However, in the semiconductor photonics device 400, the waveguide structure 104 includes a plurality of curved segments, such as a first curved segment 402 and a second curved segment 404, among other examples. The quantity of curved segments illustrated in FIG. 4 is an example, and other quantities and arrangements of curved segments for the waveguide structure 104 are within the scope of the present disclosure. Including a plurality of curved segments for the waveguide structure 104 enables crystal dislocation in the waveguide structure 104 to be confined, while enabling various arrangements of curves to be implemented in order to achieve a particular direction of propagation for the waveguide structure 104.

The first curved segment 402 of the waveguide structure 104 may be optically coupled and/or physically coupled to the grating coupler 102. A first end of the first curved segment 402 of the waveguide structure 104 (corresponding to the first end 106 of the waveguide structure 104) may be optically coupled and/or physically coupled to the grating coupler 102, and a second, opposing, end of the first curved segment 402 of the waveguide structure 104 may be optically coupled and/or physically coupled to the second curved segment 404 at a center point 406 along the length of the waveguide structure 104.

The second curved segment 404 of the waveguide structure 104 may be optically coupled and/or physically coupled to the optical splitter 110. A first end of the second curved segment 404 of the waveguide structure 104 (corresponding to a second end 108 of the waveguide structure 104) is optically coupled and/or physically coupled to the optical splitter 110. A second, opposing, end of the second curved segment 404 of the waveguide structure 104 is optically coupled and/or physically coupled to the first curved segment 402 at the center point 406. The center point 406 of the waveguide structure 104 may correspond to a point of inflection between the first curved segment 402 and the second curved segment 404.

In some implementations, the first curved segment 402 and the second curved segment 404 may be approximately point symmetric relative to the center point 406 of the waveguide structure 104. In other words, the first curved segment 402 is an affine transformation of the second curved segment 404, where the point of reflection corresponds to the center point 406, and approximately every point along the first curved segment 402 is a reflection of the second curved segment 404 across the center point 406. In some implementations, the first curved segment 402 and the second curved segment 404 may be approximately line symmetric relative to the center point 406 of the waveguide structure 104. In other words, the first curved segment 402 is a mirrored version of the second curved segment 404 along a line through the center point 406. In some implementations, the first curved segment 402 and the second curved segment 404 are asymmetric.

As further shown in FIG. 4, the first curved segment 402 and the second curved segment 404 may each have one or more dimensions. For example, the first curved segment 402 may have a first arc angle (indicated in FIG. 4 as dimension D7), and the second curved segment 404 may have a second arc angle (indicated in FIG. 4 as dimension D8). In some implementations, the first arc angle and the second arc angle are approximately equal. In some implementations, the first arc angle and the second arc angle are different arc angles.

As another example, the first curved segment 402 may have a first arc radius or arc length (indicated in FIG. 4 as dimension D9), and the second curved segment 404 may have a second arc radius or arc length (indicated in FIG. 4 as dimension D10). In some implementations, the first arc radius and the second arc radius are approximately equal. In some implementations, the first arc radius and the second arc radius are different arc radii.

As indicated above, FIG. 4 is provided as an example. Other examples may differ from what is described with regard to FIG. 4.

FIG. 5 is a diagram of an example of a semiconductor photonics device 500 described herein. The semiconductor photonics device 500 may include a photonic integrated circuit that includes one or more components configured to process optical signals (e.g., for optical communication).

As shown in FIG. 5, the semiconductor photonics device 500 includes a similar combination and arrangement of optical components as the semiconductor photonics device 100. For example, the semiconductor photonics device 500 may include a grating coupler 102, a waveguide structure 104, and an optical splitter 110, where the first end 106 of the waveguide structure 104 is optically coupled and/or physically coupled to the grating coupler 102, and where the second end 108 of the waveguide structure 104 is optically coupled and/or physically coupled to the optical splitter 110.

However, in the semiconductor photonics device 500, the waveguide structure 104 has an approximately U-shaped or C-shaped top view shape. In other words, the waveguide structure 104 may have an approximately 180 degree curve such that the first end 106 of the waveguide structure 104 and the second end of the waveguide structure 104 are facing the same direction. This may enable a compact footprint to be achieved for the photonic integrated circuit of the semiconductor photonics device 500.

As indicated above, FIG. 5 is provided as an example. Other examples may differ from what is described with regard to FIG. 5.

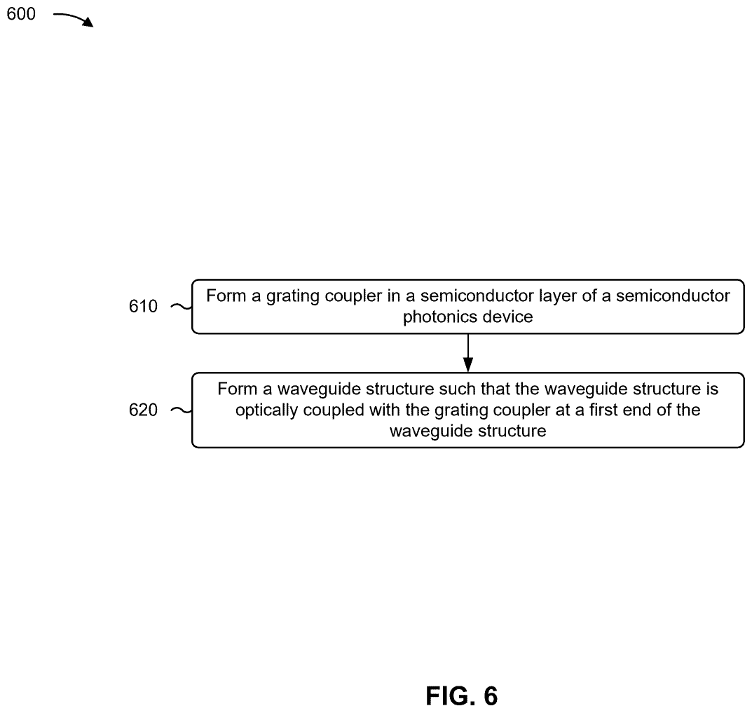

FIG. 6 is a flowchart of an example process 600 associated with forming a semiconductor photonics device described herein. In some implementations, one or more process blocks of FIG. 6 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 6, process 600 may include forming a grating coupler in a semiconductor layer of a semiconductor photonics device (block 610). For example, one or more semiconductor processing tools may be used to form a grating coupler (e.g., a grating coupler 102) in a semiconductor layer (e.g., a semiconductor layer 204) of a semiconductor photonics device (e.g., a semiconductor photonics device 100, 300, 400, and/or 500), as described herein.

As further shown in FIG. 6, process 600 may include forming a waveguide structure such that the waveguide structure is optically coupled to the grating coupler at a first end of the waveguide structure (block 620). For example, one or more semiconductor processing tools may be used to form a waveguide structure (e.g., a waveguide structure 104) such that the waveguide structure is optically coupled with the grating coupler at a first end (e.g., a first end 106) of the waveguide structure, as described herein. In some implementations, the waveguide structure has an arced top view shape between the first end and a second end (e.g., a second end 108) of the waveguide structure opposing the first end.

Process 600 may include additional implementations, such as any single implementation or any combination of implementations described below and/or in connection with one or more other processes described elsewhere herein.

In a first implementation, forming the waveguide structure includes forming the waveguide structure in the semiconductor layer.

In a second implementation, alone or in combination with the first implementation, forming the waveguide structure includes forming the waveguide structure from a dielectric layer (e.g., a dielectric layer 122, a dielectric layer 126) above the semiconductor layer.

In a third implementation, alone or in combination with one or more of the first and second implementations, forming the waveguide structure includes forming the waveguide structure such that the first end of the waveguide structure is oriented in a first direction (e.g., a y-direction) and the second end of the waveguide structure is oriented in a second direction (e.g., an x-direction) that is approximately orthogonal to the first direction.

In a fourth implementation, alone or in combination with one or more of the first through third implementations, forming the waveguide structure includes forming a base portion (e.g., a base portion 136) of the waveguide structure, and forming a core portion (e.g., a core portion 138) of the waveguide structure on the base portion.

In a fifth implementation, alone or in combination with one or more of the first through fourth implementations, forming the base portion of the waveguide structure includes forming the base portion such that the base portion has a non-uniform thickness (e.g., a dimension D3) between the first end and the second end.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

In this way, a semiconductor photonics device includes a curved waveguide structure (e.g., a waveguide structure having a bended top view shape) that is optically coupled to a grating coupler that is configured to receive high-powered optical signals. The curvature of the waveguide structure resists concentration of optical power in certain areas within the waveguide structure, which enables the waveguide structure to handle the high-powered optical signals without (or with minimal likelihood of) being damaged by the high-powered optical signals. This enables the waveguide structure to support and facilitate high signal speeds and high optical bandwidth in the semiconductor photonics device, which enables a high system link budget to be achieved for optical communication.

As described in greater detail above, some implementations described herein provide a semiconductor photonics device. The semiconductor photonics device includes a grating coupler. The semiconductor photonics device includes a waveguide structure, where a first end of the waveguide structure is optically coupled with the grating coupler, and where the waveguide structure has a curved top view shape between the first end and a second end of the waveguide structure opposing the first end.

As described in greater detail above, some implementations described herein provide a semiconductor photonics device. The semiconductor photonics device includes a grating coupler. The semiconductor photonics device includes a waveguide structure. The semiconductor photonics device includes an optical splitter, where a first curved segment of the waveguide structure is optically coupled with the grating coupler, and where a second curved segment of the waveguide structure is optically coupled with the optical splitter.

As described in greater detail above, some implementations described herein provide a method. The method includes forming a grating coupler in a semiconductor layer of a semiconductor photonics device. The method includes forming a waveguide structure such that the waveguide structure is optically coupled with the grating coupler at a first end of the waveguide structure, where the waveguide structure has an arced top view shape between the first end and a second end of the waveguide structure opposing the first end.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a grating coupler; and
a waveguide structure,
wherein a first end of the waveguide structure is optically coupled with the grating coupler, and
wherein the waveguide structure has a curved top view shape between the first end and a second end of the waveguide structure opposing the first end.

2. The semiconductor photonics device of claim 1, wherein an angle between the first end of the waveguide structure and the second end of the waveguide structure is included in a range of approximately 30 degrees to approximately 90 degrees.

3. The semiconductor photonics device of claim 1, wherein the waveguide structure has a semi-circular top view shape between the first end of the waveguide structure and the second end of the waveguide structure.

4. The semiconductor photonics device of claim 1, wherein the waveguide structure has a semi-elliptical top view shape between the first end of the waveguide structure and the second end of the waveguide structure.

5. The semiconductor photonics device of claim 1, wherein the waveguide structure comprises a silicon (Si) waveguide structure.

6. The semiconductor photonics device of claim 5, wherein the first end of the waveguide structure is physically coupled to the grating coupler.

7. The semiconductor photonics device of claim 1, wherein the waveguide structure comprises a dielectric waveguide structure.

8. A semiconductor photonics device, comprising:
a grating coupler;
a waveguide structure; and
an optical splitter,
wherein a first curved segment of the waveguide structure is optically coupled with the grating coupler, and
wherein a second curved segment of the waveguide structure is optically coupled with the optical splitter.

9. The semiconductor photonics device of claim 8, wherein a first end of the first curved segment of the waveguide structure is physically coupled to the grating coupler; and
wherein a second opposing end of the first curved segment of the waveguide structure is physically coupled to the second curved segment.

10. The semiconductor photonics device of claim 8, wherein a first end of the second curved segment of the waveguide structure is physically coupled to the optical splitter; and
wherein a second opposing end of the second curved segment of the waveguide structure is physically coupled to the first curved segment.

11. The semiconductor photonics device of claim 8, wherein the first curved segment and the second curved segment are approximately point symmetric relative to a center point of the waveguide structure.

12. The semiconductor photonics device of claim 8, wherein the center point of the waveguide structure corresponds to a point of inflection between the first curved segment and the second curved segment.

13. The semiconductor photonics device of claim 8, wherein the first curved segment has a first arc angle;
wherein the second curved segment has a second arc angle; and
wherein the first arc angle and the second arc angle are different arc angles.

14. The semiconductor photonics device of claim 8, wherein the first curved segment has a first arc radius;
wherein the second curved segment has a second arc radius; and
wherein the first arc radius and the second arc radius are different arc radii.

15. A method, comprising:
forming a grating coupler in a semiconductor layer of a semiconductor photonics device; and
forming a waveguide structure such that the waveguide structure is optically coupled with the grating coupler at a first end of the waveguide structure,
wherein the waveguide structure has an arced top view shape between the first end and a second end of the waveguide structure opposing the first end.

16. The method of claim 15, wherein forming the waveguide structure comprises:
forming the waveguide structure in the semiconductor layer.

17. The method of claim 15, wherein forming the waveguide structure comprises:
forming the waveguide structure from a dielectric layer above the semiconductor layer.

18. The method of claim 15, wherein forming the waveguide structure comprises:
forming the waveguide structure such that the first end of the waveguide structure is oriented in a first direction and the second end of the waveguide structure is oriented in a second direction that is approximately orthogonal to the first direction.

19. The method of claim 15, wherein forming the waveguide structure comprises:
forming a base portion of the waveguide structure; and
forming a core portion of the waveguide structure on the base portion.

20. The method of claim 19, wherein forming the base portion of the waveguide structure comprises:
forming the base portion such that the base portion has a non-uniform thickness between the first end and the second end.
